(19) United States
(12) Patent Application Publication
(10) Pub. No.: US 2012/0327643 A1
(43) Pub. Date: Dec. 27, 2012

(54) HANDS-FREE LIGHTING SYSTEM

(76) Inventor: Ronald C. NGUYEN, Fountain Valley, CA (US)

(21) Appl. No.: 13/531,465

(22) Filed: Jun. 22, 2012

Related U.S. Application Data
(60) Provisional application No. 61/499,699, filed on Jun. 22, 2011.

(51) Int. Cl. F21L 4/00

(52) U.S. Cl. 362/190

(57) ABSTRACT

A hands-free lighting system is described. The hands-free lighting system comprises a light and a battery housing coupled to the light. The battery housing is configured to be worn by a user. The hands-free lighting system also comprises a power switch coupled to the battery housing. The power switch is configured to be operated by a part of the arm of the user other than the hands.

### CROSS-REFERENCE TO RELATED APPLICATION

This application claims the benefit of U.S. provisional patent application Ser. No. 61/499,699, filed Jun. 22, 2011, which is incorporated by reference in its entirety.

### BACKGROUND

Loupe lights are lights attached to dental loupes or other eyewear to illuminate an area of interest. Loupe lights may be coupled by a wire to a battery pack or other power source.

Loupe lights may be turned on and off by a user. Loupe lights may also need to have a brightness adjusted. Power and brightness controls may be located on the battery pack.

However, a user may not be able to operate the power and brightness controls with the user's hands. The user's hands may be holding instruments. The user's hands may be soiled, and the user may wish to avoid soiling the battery pack and/or the user's clothing. The user's eyes may be focused on an area of interest, and the user may find it disadvantageous to look away from the area of interest to operate controls on the battery pack. Often, the user may have another person such as an assistant operate the controls.

What is needed is a light which may be turned on and off by a user without using the user's hands. What is also needed is a light which may be adjusted in brightness by a user without using the user's hands.

### SUMMARY

A hands-free lighting system is described. The hands-free lighting system comprises a light and a battery housing coupled to the light. The battery housing is configured to be worn by a user. The hands-free lighting system also comprises a power switch coupled to the battery housing. The power switch is configured to be operated by a part of the arm of the user other than the hands.

### BRIEF DESCRIPTION OF THE DRAWINGS

FIG. 1A shows one embodiment of a hands-free lighting system 100.

FIGS. 1B-1C show front and back views of one embodiment of battery housing 120.

FIGS. 1D-1F show alternative embodiments of power switch 140.

FIG. 1G shows brightness control 150 combined with power switch 140 into a single button 144.

FIG. 2A shows another embodiment of a hands-free lighting system 200.

FIG. 2B shows a front view of one embodiment of battery housing 220.

FIG. 3A shows yet another embodiment of a hands-free lighting system 300.

FIG. 3B shows power switch 240 as both pod buttons 234. FIG. 3C shows power switch 240 as a first pod button 234, and brightness control 250 as a second pod button 234.

FIG. 4A shows still another embodiment of a hands-free lighting system 400.

FIG. 4B shows power switch 240 as button 244 used as an on button and pod button 234 used as an off button.

FIG. 4C shows power switch 240 as button 244 and brightness control 250 as button 234.

### DESCRIPTION

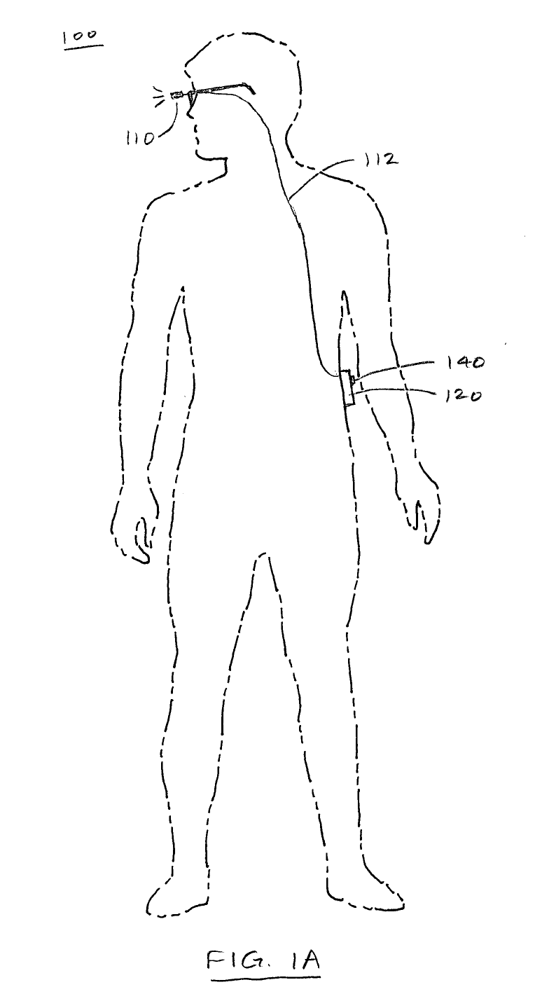

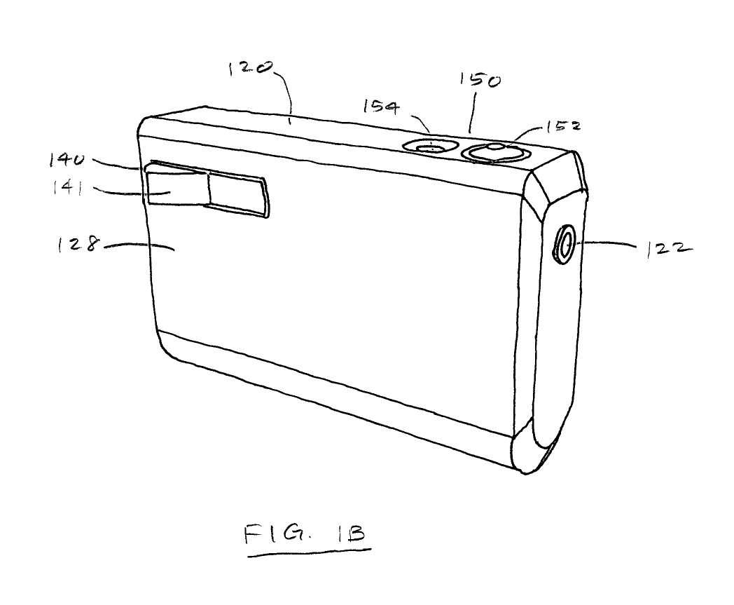

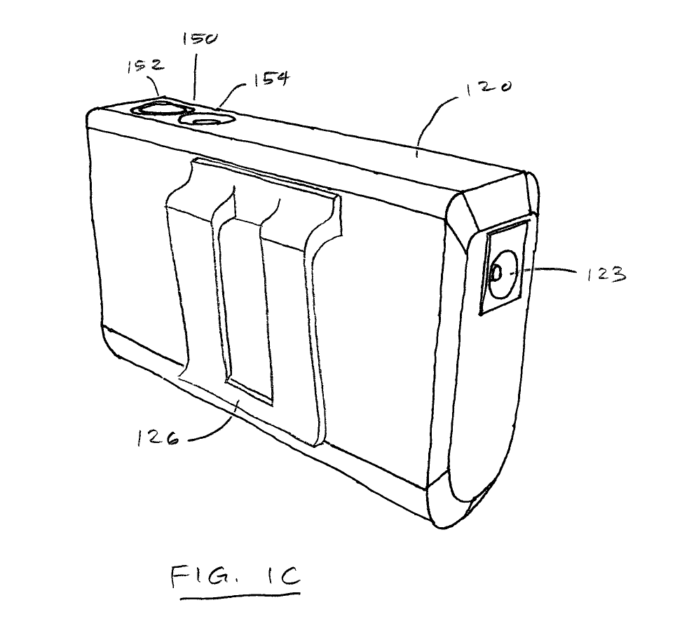

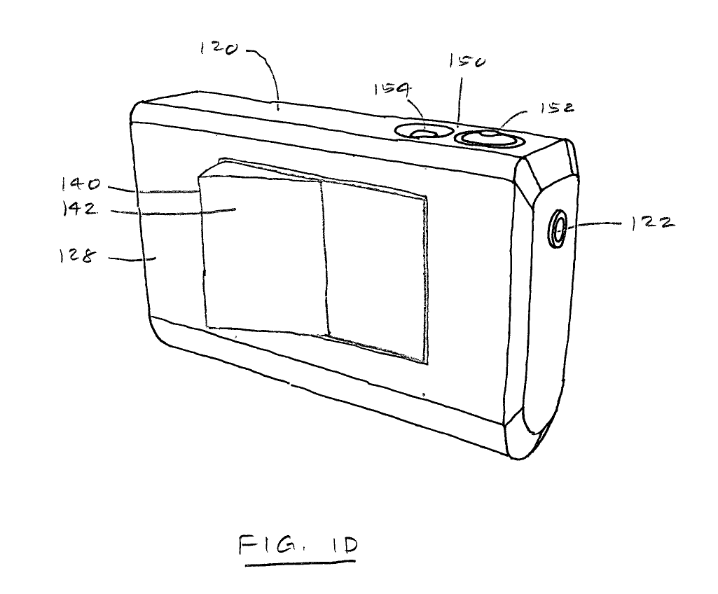

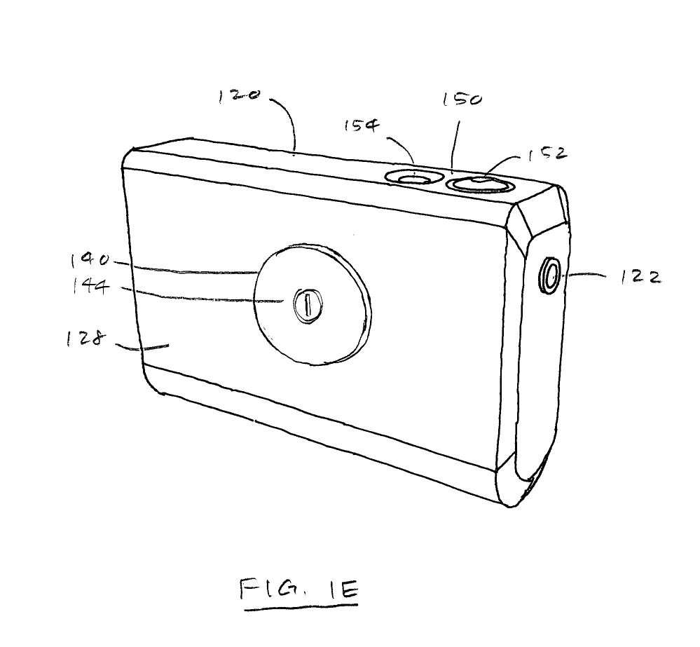

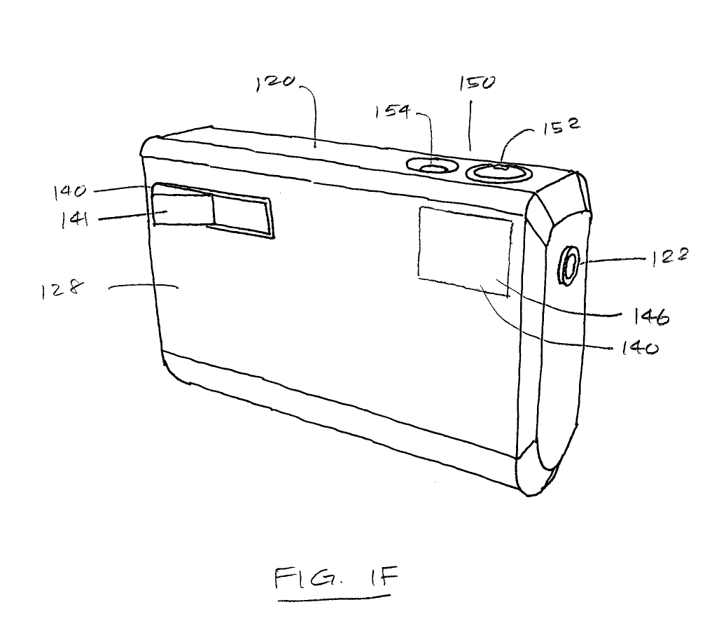

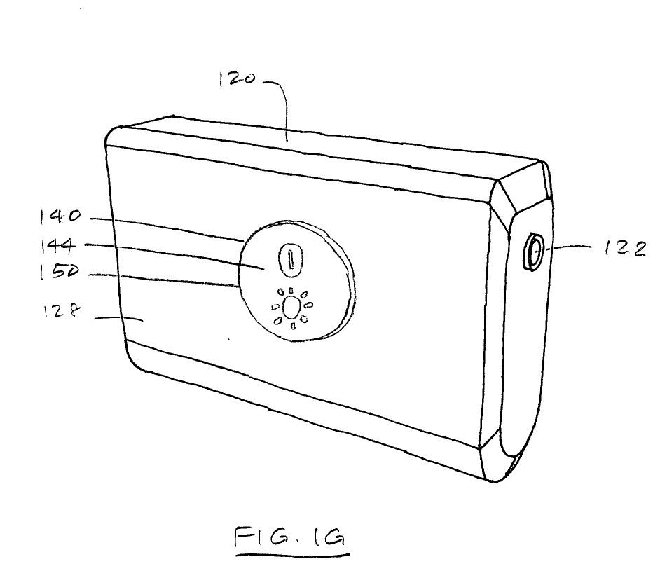

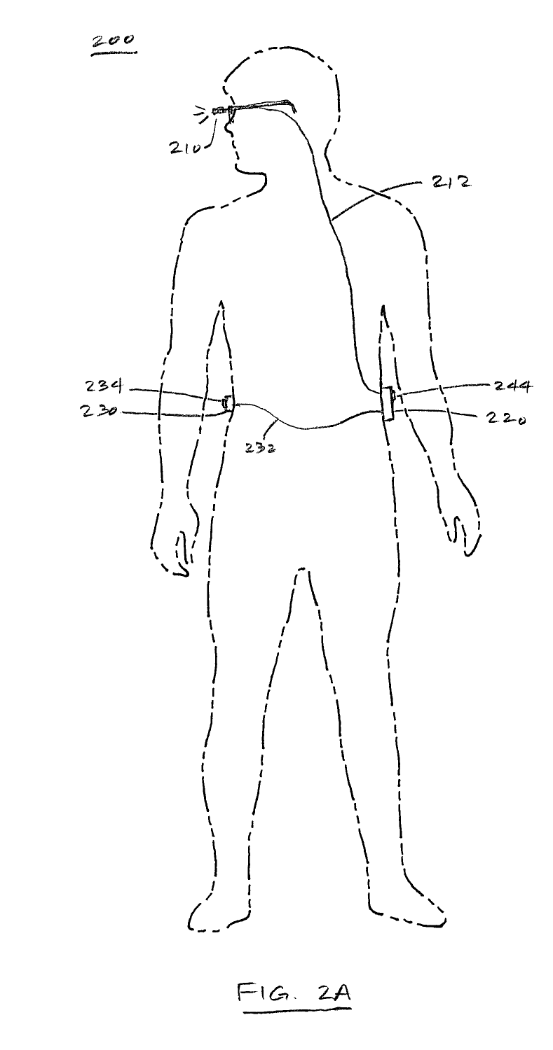

FIG. 1A shows one embodiment of a hands-free lighting system 100. Hands-free lighting system 100 includes a light 110, a battery housing 120, a power switch 140, and a brightness control 150.

Light 110 is shown as a loupe light, but may be any light for which hands-free operation is desired. Light 110 may include a wire 112 for connecting to a battery or power source.

FIGS. 1B-1C show front and back views of one embodiment of battery housing 120. Battery housing 120 is configured to contain a battery. Battery housing 120 may be sealed. Alternatively, battery housing 120 may be able to be opened to install or replace a battery. A light connector 122 may be located on battery housing 120 for connecting wire 112 of light 110. Alternatively, wire 112 of light 110 may be non-removably coupled to battery housing 120. Battery housing 120 may include a recharging port 123 for connecting to a power source to charge rechargeable batteries. Battery housing 120 may include an attachment 126 so that battery housing 120 may be worn by a user. Attachment 126 may be a belt clip, a belt loop, a hook-and-loop fastener, a strap, or any other suitable device which allows battery housing 120 to be worn by a user.

Battery housing 120 may have a slim or flat profile when worn against the user. Battery housing 120 may be worn on the side of the torso of the user, such as at the waist or under the armpit. Alternatively, battery housing 120 may be worn on the thigh of the user or any other suitable location. Battery housing 120 has an outer surface 128 which faces away from the user when worn by the user.

Power switch 140 allows a user to turn light 110 on and off. FIG. 1B shows power switch 140 as a rocker switch 141 located on outer surface 128 of battery housing 120. Power switch 140 is configured to be operated by a part of the arm of the user other than the hands. Power switch 140 may be operated by the inside of the elbow of the user. Alternatively, power switch 140 may be operated by the wrist, forearm, upper arm, or any other part of the arm of the user other than the hands.

FIGS. 1D-1F show alternative embodiments of power switch 140. FIG. 1D shows power switch 140 as a larger rocker switch 142. Larger rocker switch 142 may facilitate operation using a part of the arm other than the hands. FIG. 1E shows power switch 140 as a power button 144. Power button 144 may be pushed once to turn on light 110. Alternatively, power button 144 may be pushed and held down for a period of time to turn on light 110, or pushed two or more times to turn on light 110. Power button 144 may be used in the same or different way to turn off light 110. FIG. 1F shows power switch 140 as a touch-sensitive device 146. Touch-sensitive device 146 may include a capacitive surface responsive to touch and/or near-touch. Touch-sensitive device 146 may be responsive to bare and/or clothed skin. Touch-sensitive device 146 may be configured to be touched or near-touched for a period of time before turning on or off light 110 to prevent inadvertent operation. For example, touch-sensitive device 146 may need to be touched or near-touched for 0.5 sec to 1 sec before turning on or off light 110. Touch-sensitive device 146 may be substantially flush with outer surface 128. Touch-sensitive device 146 may be made any suitable size or shape. Touch-sensitive device 146 may be used alone or in conjunction with another power switch 140. Touch-sensitive device 146 may be used to control brightness. Touch-sensitive device 146 or additional touch-sensitive devices may be used instead of some or all of the buttons or switches for any of the devices described herein.

Brightness control 150 allows a user to adjust the brightness of light 110. FIGS. 1B-1E show brightness control 150 as a plus button 152 and a minus button 154 for increasing and decreasing, respectively, a brightness of light 110. Plus button 152 and minus button 154 may be textured differently, be convex or concave, or otherwise have different profiles to allow a user to distinguish between the two without looking. Alternatively, brightness control 150 may be a single button which increases the brightness of light 110 with each push, and returns to the lowest brightness when the button is pushed after the maximum brightness is reached. Brightness control 150 may be located on a surface of battery housing 120 other than outer surface 128 to avoid inadvertent operation of brightness control 150. FIG. 1G shows brightness control 150 combined with power switch 140 into a single button 144 which turns on or increases the brightness of light 110 with each push, and returns light 110 to off when the button is pushed after the maximum brightness is reached.

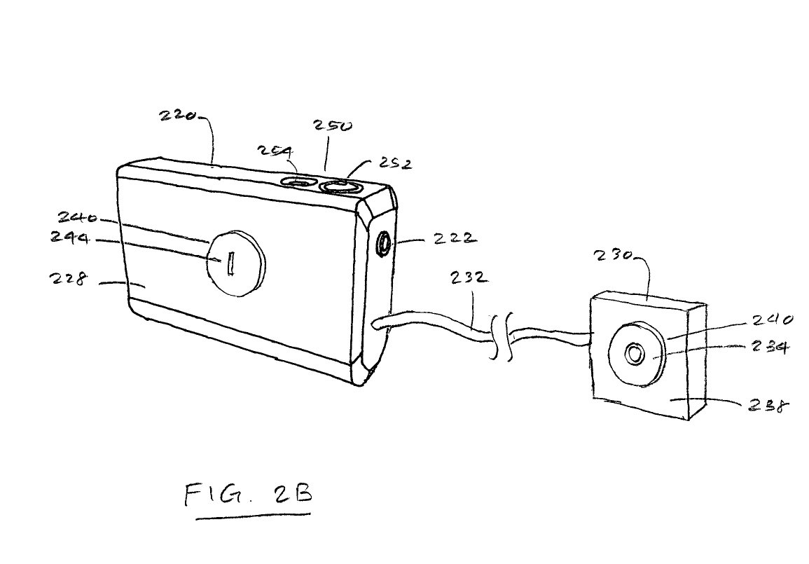

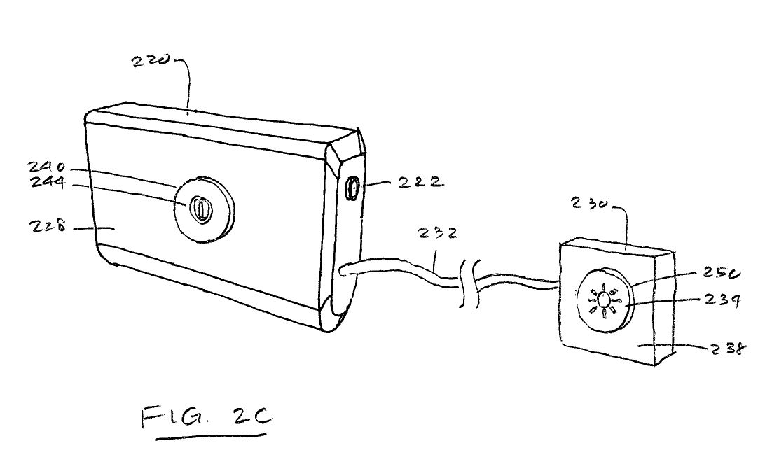

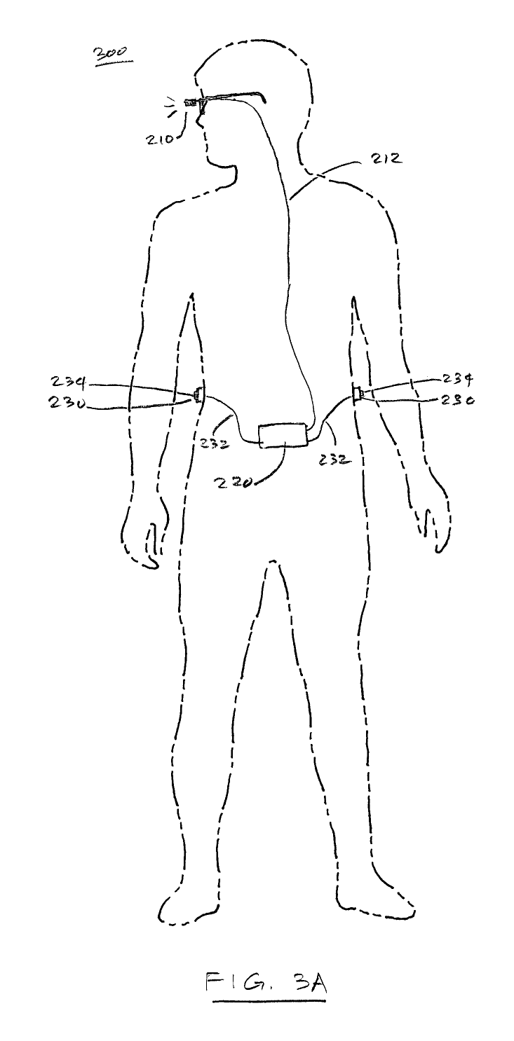

FIG. 2A shows another embodiment of a hands-free lighting system 200. Hands-free lighting system includes a light 210, a battery housing 220, a pod 230, a power switch 240, and a brightness control 250.

Light 210 is shown as a loupe light, but may be any light for which hands-free operation is desired. Light 210 may include a wire 212 for connecting to a battery or power source.

FIG. 2B shows a front view of one embodiment of battery housing 220. Battery housing 220 is configured to contain a battery. Battery housing 220 may be sealed. Alternatively, battery housing 220 may be able to be opened to install or replace a battery. A light connector 222 may be located on battery housing 220 for connecting to wire 212 of light 210. Alternatively, wire 212 of light 210 may be non-removably coupled to battery housing 220. Battery housing 220 may include a recharging port 223 for connecting to a power source to charge rechargeable batteries. Battery housing 220 may include an attachment 226 so that battery housing 220 may be worn by a user. Attachment 226 may be a belt clip, a belt loop, a hook-and-loop fastener, a strap, or any other suitable device which allows battery housing 220 to be worn by a user.

Battery housing 220 may have a slim or flat profile when worn against the user. Battery housing 220 may be worn on the side of the torso of the user, such as at the waist or under the armpit. Alternatively, battery housing 220 may be worn on the thigh of the user or any other suitable location. Battery housing 220 has an outer surface 228 which faces away from the user when worn by the user.

Pod 230 is connected to battery housing 220 by a wire 232. Pod 230 may be removably or non-removably connected to battery housing 220. Pod 230 includes a pod button 234. Pod 230 may also include an attachment 236 similar to attachment 226 on battery housing 220, so that pod 230 may be worn by a user.

Power switch 240 allows a user to turn light 210 on and off. FIG. 2B shows power switch 240 as a button 244 used as an on button located on outer surface 228 of battery housing 220, and pod button 234 used as an off button. Alternatively, power switch 240 may be button 244 used as an off button, and pod button 234 used as an on button. Power switch 240 is configured to be operated by a part of both arms of the user other than the hands. Power switch 240 may be operated by the insides of the elbows of the user. Alternatively, power switch 240 may be operated by the wrists, forearms, upper arms, or any other parts of the arms of the user other than the hands.

Battery housing 220 and pod 230 may be worn on both sides of a body of a user so that button 244 and pod button 234 may be operated by a part of both arms of the user other than the hands. One arm may operate button 244 while the other may operate pod button 234. Button 244 or pod button 234 used as an on button may be pushed once to turn on light 210. Alternatively, button 244 or pod button 234 used as an on button may be pushed and held down for a period of time to turn on light 210, or pushed two or more times to turn on light 210. Button 244 or pod button 234 used as an off button may be used in the same or different way to turn off light 210.

Brightness control 250 allows a user to adjust the brightness of light 210. FIG. 2B shows brightness control 250 as a plus button 252 and a minus button 254 for increasing and decreasing, respectively, a brightness of light 210. Plus button 252 and minus button 254 may be textured differently, be convex or concave, or otherwise have different profiles to allow a user to distinguish between the two without looking. Brightness control 250 may be located on a surface of battery housing 220 other than outer surface 228 to avoid inadvertent operation of brightness control 250. FIG. 2C shows brightness control 250 as pod button 234, and power switch 240 as button 244. Brightness control 250 may increase the brightness of light 210 with each push of pod button 234, and returns to the lowest brightness when pod button 234 is pushed after the maximum brightness is reached. Alternatively, brightness control 250 may be button 244, and power switch 240 may be button 234.

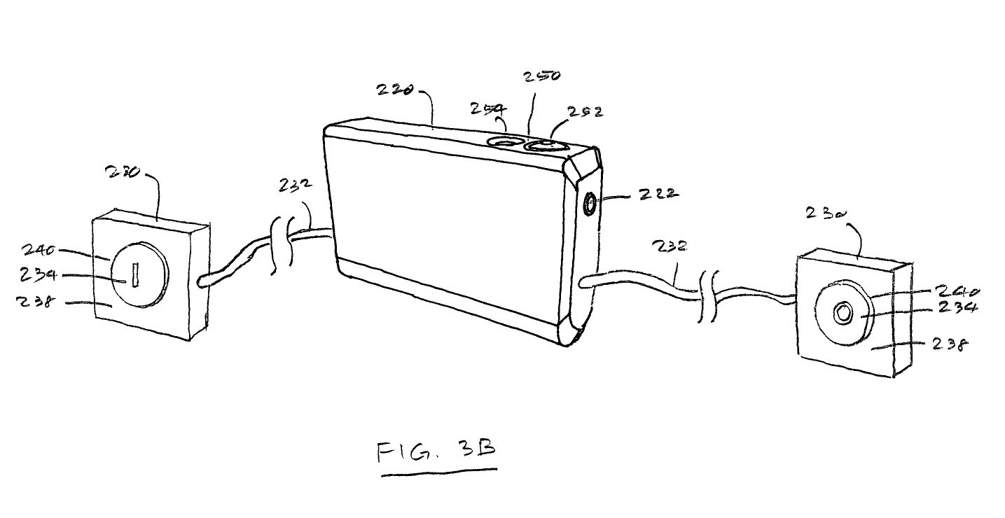

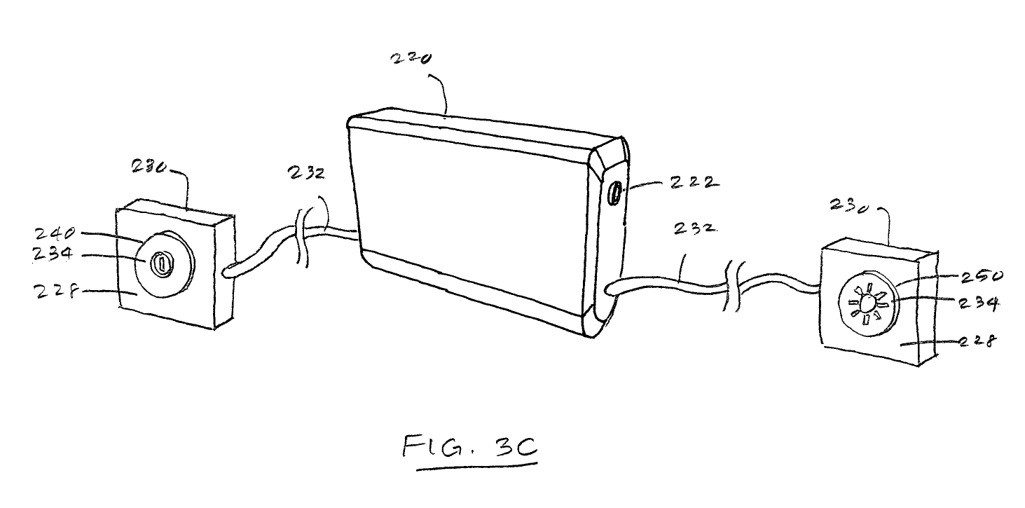

FIG. 3A shows yet another embodiment of a hands-free lighting system 300. Hands-free lighting system 300 is similar to hands-free lighting system 200, with two pods 230.

FIG. 3B shows power switch 240 as both pod buttons 234, with a first pod button 234 turning on light 210 on and a second pod button 234 turning off light 210. Brightness control 250 is located on battery housing 220. FIG. 3C shows power switch 240 as a first pod button 234, and brightness control 250 as a second pod button 234.

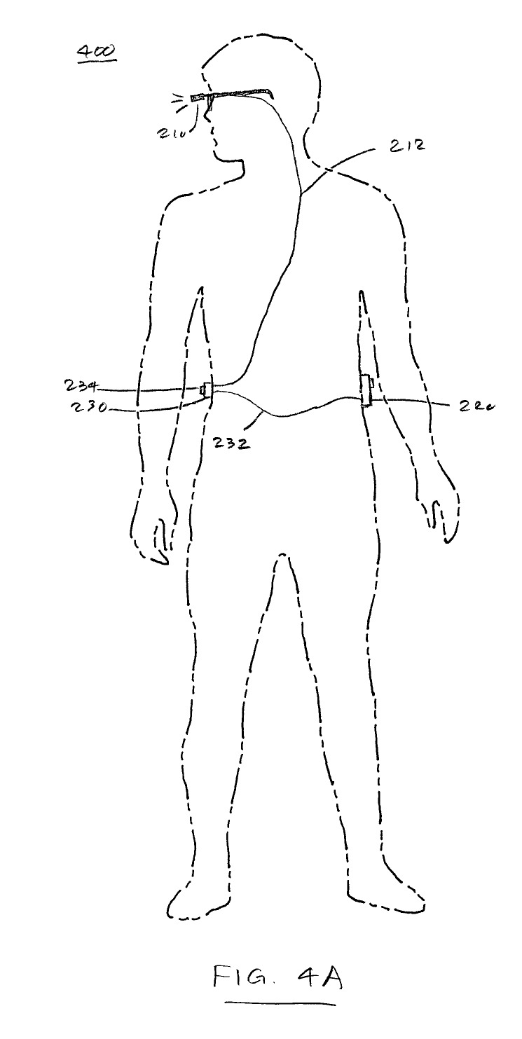

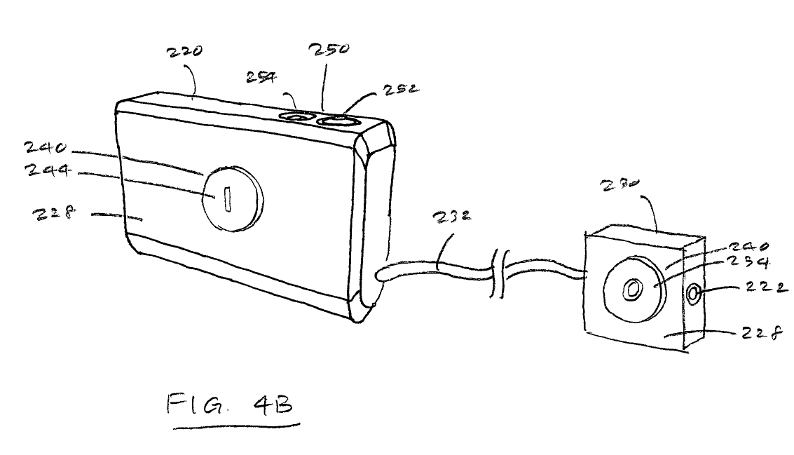

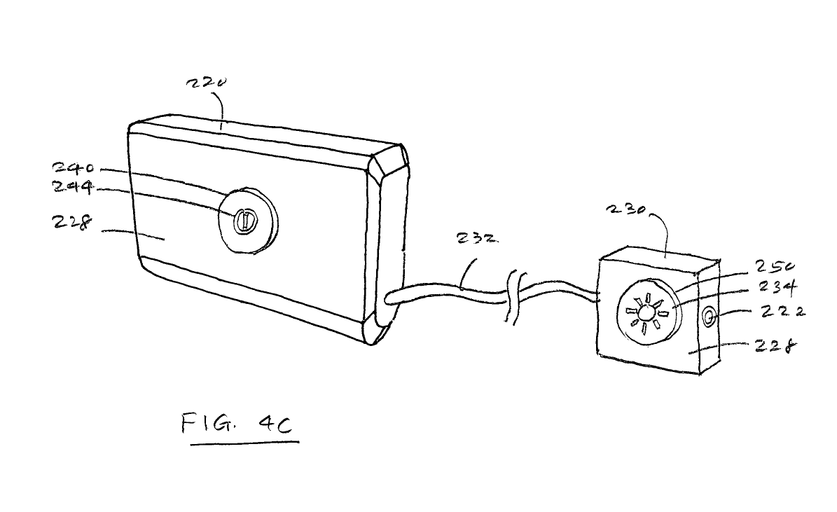

FIG. 4A shows still another embodiment of a hands-free lighting system 400. Hands-free lighting system is similar to hands-free lighting system 200, with a light connector 122 on pod 230 for connecting wire 212 of light 110. Alternatively, wire 212 of light 210 may be non-removably coupled to pod 230.

FIG. 4B shows power switch 240 as button 244 used as an on button and pod button 234 used as an off button. Alternatively, power switch 240 may be button 244 used as an off button, and pod button 234 used as an on button.

FIG. 4C shows power switch 240 as button 244 and brightness control 250 as button 234. Alternatively, power switch 240 may be button 234, and brightness control 250 may be button 244.

While the foregoing has been with reference to particular embodiments of the invention, it will be appreciated by those skilled in the art that changes in these embodiments may be made without departing from the principles and spirit of the invention.

1. A hands-free lighting system comprising:
a light;
a battery housing coupled to the light, the battery housing configured to be worn by a user; and
a power switch coupled to the battery housing, the power switch configured to be operated by a part of the arm of the user other than the hands.

2. The lighting system of claim 1, wherein the power switch is located on the battery housing.

3. The lighting system of claim 1, wherein the power switch includes a rocker switch.

4. The lighting system of claim 1, wherein the power switch includes a power button.

5. The lighting system of claim 4, wherein the power button is configured to be operated by a same arm of the user.

6. The lighting system of claim 1, wherein the power switch includes an on button and an off button.

7. The lighting system of claim 6, wherein the on button and the off button are configured to be worn on a first side and a second side, respectively, of the user.

8. The lighting system of claim 6, wherein the on button and the off button are configured to be operated by a first arm and a second arm, respectively, of the user.

9. The lighting system of claim 6, wherein the on button and the off button are located on one or more pods coupled to the battery housing.

10. The lighting system of claim 1, wherein the light is coupled to the battery housing by a wire, and wherein the power switch is located on the wire.

11. The lighting system of claim 1, wherein the part of the arm is an inside of an elbow.

12. The lighting system of claim 11, wherein the power switch is sized and shaped to receive the inside of the elbow.

13. The lighting system of claim 11, further comprising:
a brightness control coupled to the battery housing, the brightness control configured to be operated by a part of the arm other than the hands.

14. The lighting system of claim 13, wherein the brightness control includes a brightness control button.

15. The lighting system of claim 13, wherein the power switch and the brightness control are configured to be worn on a first side and a second side, respectively, of the user.

16. The lighting system of claim 13, wherein the power switch and the brightness control are configured to be operated by a first arm and a second arm, respectively, of the user.

17. The lighting system of claim 13, wherein the power switch and the brightness control are located on one or more pods coupled to the battery housing.

18. The lighting system of claim 13, wherein the light is coupled to the battery housing by a wire, and wherein the brightness control is located on the wire.

19. A method of operating a hands-free lighting system, the method comprising:
providing the light of claim 1; and
turning the light on and off by using the part of the arm other than the hands to operate the power switch.

20. A method of operating a hands-free lighting system, the method comprising:
providing the light of claim 4;
turning the light on by using the part of the arm other than the hands to press the power button a first time; and
turning the light off by using the part of the arm other than the hands to press the power button a second time.

21-24. (canceled)
